(19) United States
(12) Patent Application Publication
(10) Pub. No.: US 2007/0114264 A1
(43) Pub. Date: May 24, 2007

(54) Mesotube electode attachment

(76) Inventors: Barrett E. Cole, Bloomington, MN (US); Khanh Q. Nguyen, Bloomington, MN (US); Leonard A. Hilton, Buffalo, MN (US)

Correspondence Address: Kris T. Fredrick;Patent Services, Honeywell International Inc., 101 Columbia Road, Morristown, NJ, 07962, US

(21) Appl. No.: 11/283,203

(22) Filed: Nov. 18, 2005

(51) Int. Cl. B23K 37/04; B23K 31/02

(52) U.S. Cl. 228/49.5; 228/212

(57) ABSTRACT

A device for positioning a shaped element on a surface of another element mounted on a mechanism to permit welding the element to the surface. An insulating fixture mounts the device on the mechanism and positions an extension having a clamp locating end that positions a clamp for holding the shaped element in a precise position in contact with the surface during welding. The clamp is conductive and directs current from the welding to the insulating fixture and prevent passage of current on the shaped element beyond the clamp.

### FIELD OF THE INVENTION

The present invention relates to mesotube construction. More particularly, the invention relates to construction of mesotubes in which the electrodes that support mesotube grids in a precisely aligned configuration.

### BACKGROUND OF THE INVENTION

In many electronic devices such as mesotubes and the like, it is necessary to place grids or other plates in precise relationship to other similar grids or plates. In a mesotube, the grids must be essentially parallel to each other and must be spaced by a precise distance to operate efficiently. The grids or plates are supported on electrodes that permit the device to function.

For example, a tungsten lower grid in a typical mesotube is to be supported on three header pins or electrodes that are perpendicular to the plane of the grid and the upper grid is to be supported on three other header pins or electrodes that also are perpendicular to that grid. The two grids are to be spaced by a precise distance, in one design by 15 to 20 mils with a tolerance of no more than about ±1 mil. The preferred method of attaching the grids to the electrodes, as is done in many present day electronic devices using grids, is to spot weld the grid to the electrode.

In prior attempts to accomplish precise placement and orientation of grids on the ends of header pins or electrodes, direct spot welding on the heard pins has failed. The pins are often made from a nickel plated Kovar, which is a Westinghouse trade name for an alloy of iron, nickel and cobalt, that has the same thermal expansion as glass and for that reason is often used for glass-to-metal or ceramic-to-metal seals. The problem with spot welding is that the pins or electrodes are held in place by insulators and these insulators do not survive the heat of the welding process. Production failure renders the use of the device much more expensive than necessary.

It would be an advantage in the art if a way could be devised that would permit spot welding of pins and electrodes to plates and grids without damage to adjacent components such as insulators.

Yet another advantage would be if a device could be provided that would not only protect adjacent components but would assist in the precise alignment of the pins and electrodes with respect to the grids or plates to insure proper alignment and optimum functional results.

Other advantages will appear hereinafter.

### SUMMARY OF THE INVENTION

It has now been discovered that the above and other advantages of the present invention may be obtained in the following manner. Specifically, the present invention provides a device for gripping the pin or electrode and directing the weld heat away from other components.

The device includes a support or insulating fixture for mounting the device that has a shaft extending up and parallel to the electrode or pin being attached to a plate or grid. The fixture is referenced to the header floor in which the pins are precisely located and connected. The insulating fixture prevents any conductive paths from the clamp electrode to the header base through the insulators and locates the header pins precisely with respect to the top weld electrode. This top weld electrode pushes the plate or grid against the pin being welded to it. The clamp is preferably a spring loaded, split ring, conducting clamp.

In operation, the fixture is put in place proximate the specific pin being welded, the clamp grips the pin and is maintained in contact with its spring loading. The grid or plate is place in the desired position in contact with the pin, a welding electrode is placed on the other side of the grid, and welding takes place. The heat passes through the welding electrode, through the grid, into the pin and is then diverted from the pin to the clamp, thus insulating the remaining portion of the pin and the equipment associated with it.

### BRIEF DESCRIPTION OF THE DRAWINGS

For a more complete understanding of the invention, reference is hereby made to the drawings, in which:

FIG. 1 is a schematic view of a mesotube being assembled; and

FIG. 2 is a top view of the clamp of this invention.

In the figures, like reference characters designate identical or corresponding components and units throughout the several views.

### DETAILED DESCRIPTION OF THE PREFERRED EMBODIMENT

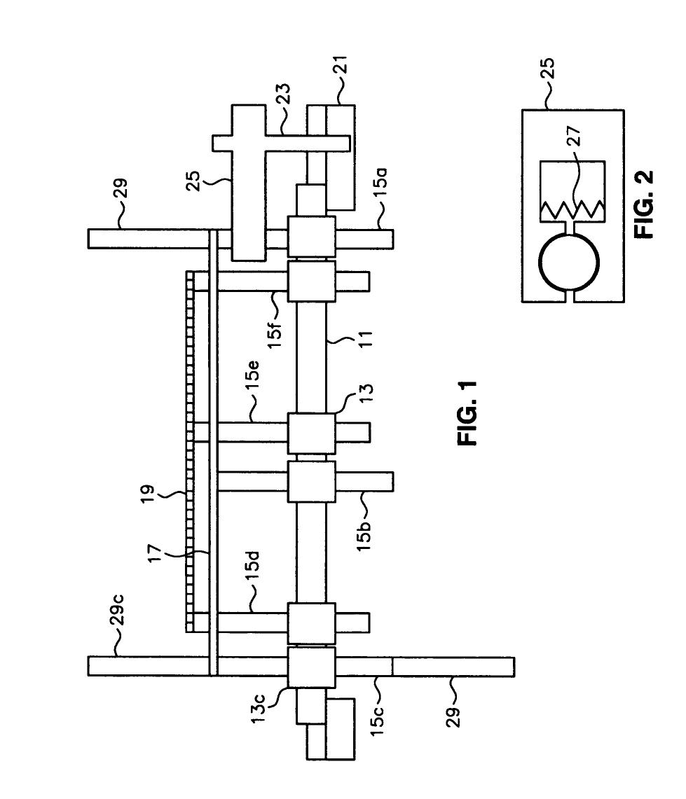

The present invention is admirably suited for attaching grids, plates and other flat objects to pins, posts, electrodes and other components that are conductive and perpendicular to the first object. FIG. 1 illustrates a typical application of the present invention, in which mesotube grids are attached to a plurality of pins. As can be appreciated, the mesotube shown in FIG. 1 only shown the internal components of grids, pins and insulators, and the whole device is not illustrated.

Header 11 is provided for mounting the various components of the mesotube, and includes insulators 13 that mount and support pins 15. A top view would show header 11 as a circular plate on which the insulators 13 and pins 15 are positioned so that three pins 15a, 15b and 15c are positioned to contact and support tungsten grid 17 and three more pins 15d, 15e and 15f are positioned to contact and support upper grid 19. Tungsten grid 17 is about 4 mil thick in this example. This is conventional construction, though the manner in which the grids are attached to the pins is not.

As shown on the right side of FIG. 1, an insulating fixture 21 is mounted to header 11. Fixture 21 supports shaft 23, which in turn positions clamp 25 in the appropriate alignment to allow clamp 25 to engage a pin, in this case pin 15a using spring 27 as seen in FIG. 2. Wafer 17 is then spot welded to pin 15a by applying electrode 29 to the other side of wafer 17 and welding using, for example, a 400 volt welding potential. Current passes through the electrode 29 into wafer 17 and pin 15a. Current is prevented from reaching other parts of the mesotube such as insulator 13a as the current is directed into the body of clamp 25 and shaft 23, but is stopped by insulation fixture 21. Each pin 15a, 15b, and 15c is welded to wafer 17 individually by moving fixture 21 and thus clamp 25 to the position where clamp 25 engages the specific pin. Similarly, grid 19 is attached sequentially to pins 15d, 15e, and 15f in the same manner.

Prior art efforts to spot weld wafers to similar devices have failed because damage was done to the components of the mesotube. In FIG. 1, a prior art attempt to directly weld wafer 17 to pin 15c is shown on the left hand side where electrode 29c contacts one side of wafer 17 and welding current passes through wafer 17 into pin 15c down to insulator 13c, which is damaged and renders the device inoperative.

The present invention has been shown for use with mesotubes that employ wafers and pins to support them in precise alignment. The invention is also admirably suited for use with any similar device, electronic or not, which requires precise positioning of a flat surface on a pin or pole or other round or otherwise shaped element, perpendicularly aligned or at an angle, where spot welding is used. Accordingly, the terms wafer and pin are to be broadly interpreted to represent any such flat surface and shaped element.

While particular embodiments of the present invention have been illustrated and described, it is not intended to limit the invention, except as defined by the following claims.

1. A device for positioning a shaped element on a surface of another element mounted on a mechanism to permit welding the element to the surface, comprising:
an insulating fixture for mounting said device on said mechanism, said fixture being non conductive;
an extension attached to said fixture and having a clamp locating end;
a clamp attached to said clamp locating end of said extension for holding said shaped element in a precise position in contact with said surface during welding, said clamp being conductive and adapted to direct current from said welding to said insulating fixture and prevent passage of current on said shaped element beyond said clamp.

2. The device of claim 1, wherein said mechanism is an electronic device.

3. The device of claim 2, wherein said electronic device is a mesotube having at least two wafers to be welded to a plurality of individual pins.

4. The device of claim 3, wherein said wafers comprise a lower tungsten wafer and an upper mesotube grid and said plurality of pins comprises three pins for each wafer, said pins being positioned to align said wafers precisely a predetermined distance apart.

5. The device of claim 1, wherein said clamp includes shaped element engaging jaws and a biasing element for maintaining said jaws on said element.

6. The device of claim 5, wherein said extension is a shaft for pivoting said clamp into and out of alignment with said shaped element.

7. A device for positioning a shaped element on a surface of another element mounted on a mechanism to permit welding the element to the surface, comprising:
insulating fixture means for mounting said device on said mechanism, said fixture being non conductive;
extension means attached to said fixture for having a clamp locating end;
clamp means attached to said clamp locating end of said extension means for holding said shaped element in a precise position in contact with said surface during welding, said clamp means being conductive and adapted to direct current from said welding to said insulating fixture means and prevent passage of current on said shaped element beyond said clamp means.

8. The device of claim 7, wherein said mechanism is an electronic device.

9. The device of claim 6, wherein said electronic device is a mesotube having at least two wafers to be welded to a plurality of individual pins.

10. The device of claim 9, wherein said wafers comprise a lower tungsten wafer and an upper mesotube grid and said plurality of pins comprises three pins for each wafer, said pins being positioned to align said wafers precisely a predetermined distance apart.

11. The device of claim 7, wherein said clamp means includes shaped element engaging jaws and biasing means for maintaining said jaws on said element.

12. The device of claim 11, wherein said extension means is a shaft means for pivoting said clamp into and out of alignment with said shaped element and said biasing means is a spring.

13. A method for positioning a shaped element on a surface of another element mounted on a mechanism to permit welding the element to the surface, comprising the steps of:
mounting an insulating fixture on said mechanism, said fixture being non conductive;
positioning a clamp proximate said shaped element, said extension being attached to said fixture;
engaging said shaped element with a clamp attached to said clamp locating end of said extension and holding said shaped element in a precise position in contact with said surface during welding, said clamp being conductive and adapted to direct current from said welding to said insulating fixture and prevent passage of current on said shaped element beyond said clamp.

14. The method of claim 13, wherein said mechanism is an electronic device.

15. The method of claim 14, wherein said electronic method is a mesotube having at least two wafers to be welded to a plurality of individual pins.

16. The method of claim 15, wherein said wafers comprise a lower tungsten wafer and an upper mesotube grid and said plurality of pins comprises three pins for each wafer, said pins being positioned to align said wafers precisely a predetermined distance apart.

17. The method of claim 13, wherein said clamp includes shaped element engaging jaws and a biasing element for maintaining said jaws on said element.

18. The method of claim 17, wherein said extension is a shaft for pivoting said clamp into and out of alignment with said shaped element.
